(19) United States
(12) Patent Application Publication
(10) Pub. No.: US 2008/0211748 A1
(43) Pub. Date: Sep. 4, 2008

(54) Display Screen Addressing System

(75) Inventors: Jean-Francois Peyre, Rousset (FR); Jean-Chretien Favreau, Paris (FR); Matthieu Mauger, Villeurbanne (FR)

Correspondence Address: HEDMAN & COSTIGAN P.C., 1185 AVENUE OF THE AMERICAS, NEW YORK, NY, 10036, US

(73) Assignee: INANOV, Paris France (FR)

(21) Appl. No.: 10/530,605

(22) PCT Filed: Oct. 8, 2003
(86) PCT No.: PCT/FR03/02963

§ 371 Date: Mar. 11, 2008

(30) Foreign Application Priority Data
Oct. 10, 2002 (FR) 02/13287

(51) Int. Cl. G09G 3/30

(52) U.S. Cl. 345/77

(57) ABSTRACT

A display device comprising individual elements wherein the placement, on each element, of an electronic microcircuit capable of recognizing its address among those of other microcircuits connected in parallel to the common addressing electrodes, recording the brightness data sent to its address and modulating the brightness of its display element according to the data received.

The purpose of this invention is a display system with individual elements, in which each image point can be addressed individually through an integrated microcircuit with a unique address placed on each element.

This invention relates to the flat viewing screen field. Conventionally, these screens include a set of image elements of pixels, organized as a matrix and addressed by a network of conductors in rows and a network of conductors in columns.

According to the subject of this invention, these two networks of conductors, rows and columns, are eliminated and each display element, for example each color point of each pixel, is provided with an integrated microcircuit having a unique address. The microcircuits are connected in parallel on the common addressing electrodes, which can advantageously take the form of conducting planes and provide power to the elements.

The invention thus relates to a display device consisting of individual elements on which has been placed on each element a microcircuit containing electronic and logical devices enabling:
to record its address, in a non-volatile, permanent or reprogrammable manner. For example, an address formed from 32 bits will be chosen.
to recognize in the signals sent on the electrodes its address from among those of other microcircuits of other display elements connected in parallel to the common addressing and power supply electrodes
to temporarily record brightness data sent to its address, for example in the form of an 8-bit binary word.
to modulate the brightness of its display element according to the data received, for example by modulating the voltage at the terminals of the element or by selecting from the power pulses received by the addressing system those which will be sent to the element.
to create the direct current needed for its logical circuits, for example by a diode device and a capacitor.

In one of the embodiments of the invention, a display element and a microcircuit are placed per elementary color point of the image.

According to another embodiment, each microcircuit manages a number of color points or elementary points adjacent to the image on one or more addresses.

Advantageously, individual addresses are engraved on the microcircuit during its manufacture and remain visible for an optical reading of this said address during assembly of the display screen.

More preferably, individual addresses are written electrically in non-volatile memory area of the microcircuit during assembly of the display screen.

According to one of the embodiments, the display screen is divided into several addressing areas controlled independently and simultaneously so as to reduce the frequency of the addressing signals.

The microcircuit can also be provided advantageously with devices enabling it:
to record, in addition to its individual address and in a predefined order, the addresses of a certain number of other elements, and thus to load the brightness data sent at a given interval of the transmission of one of these other addresses, without transmitting its own address. It will have to be capable, when it detects the transmission of one of said recorded addresses, to count the number of the brightness data sent in series and without a new address, and to load the data addressed to it after the counting. In this way, an address followed by an amount of brightness data can be sent, and thus significantly reduce the data flow on the addressing electrodes. The grouping of the display elements can be arbitrary, but will be chosen so as to simplify the data processing.
to recognize touch on the screen and then to send this information back with its address to the addressing system. The contact can be detected in various ways, for example by mechanical contact with a stud mounted on the microcircuit with an electrode or by capacitive detection of the mechanical comparison of the microcircuit with an electrode, a comparison induced by the user pressing on the screen.
to correct the modulation of its display element according to a local measurement, for example of the current crossing an element, or of a coefficient transmitted by the addressing system.
to recognize certain predefined global addresses and then be placed in a preset test mode, for example to activate the lighting of the element at full brightness.

The invention will be best understood, and its objectives, advantages and characteristics will appear more clearly on reading the description which follows preferred embodiments being given as non-limiting examples, and for which a set of drawings is appended in which:

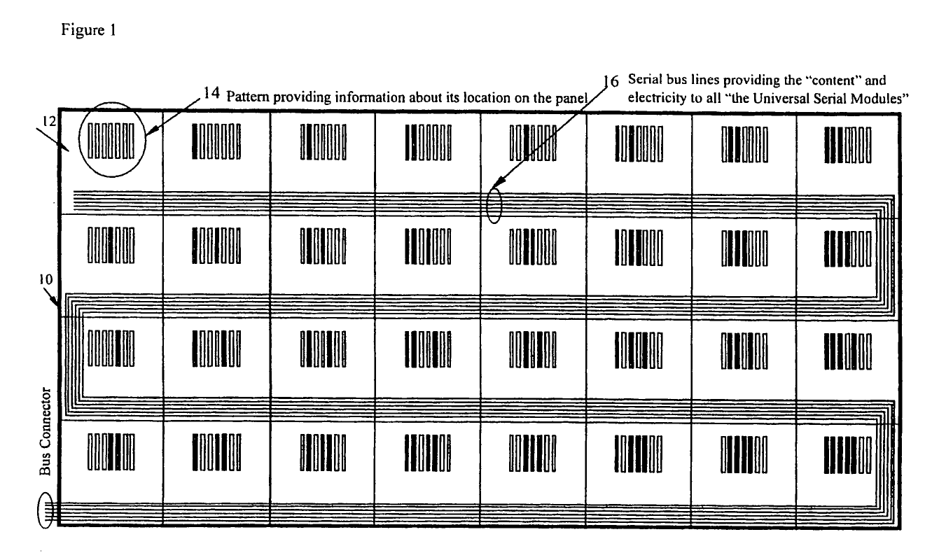

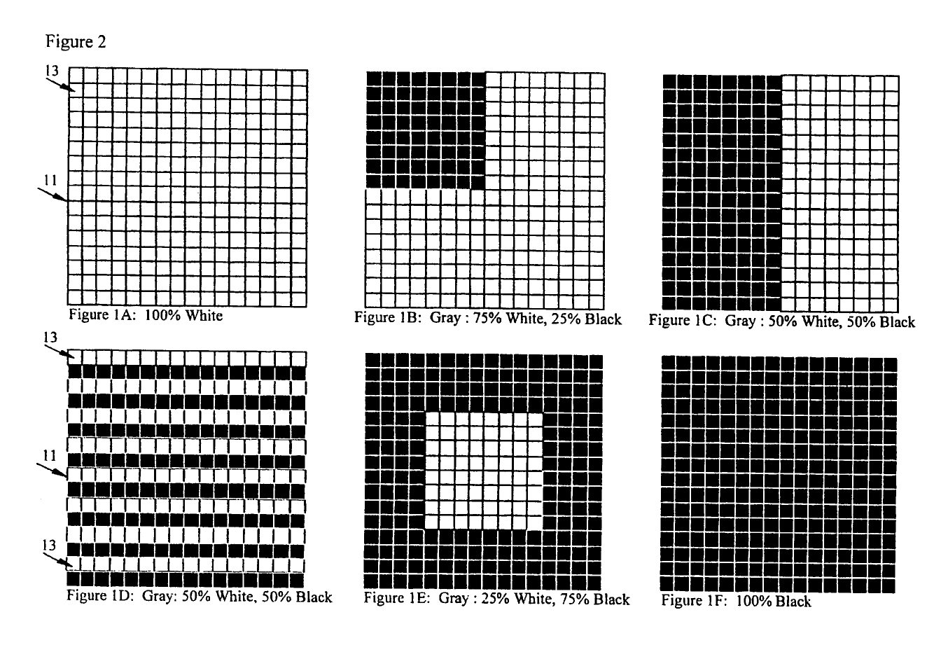

FIGS. 1 to 6 are schematic representations of a display element according to this invention.

FIG. 1 represents an embodiment of this invention in which the display element 11, with two electrodes 13, is connected to the microcircuit 12, this microcircuit being itself connected to two common addressing electrodes 14.

FIG. 2 represents an embodiment in which the display element 21, for example a cathode ray tube with field emission, includes three electrodes, for example the emitter 23, the anode with luminophores 25 and the control grid 24. In this particular embodiment, the anodes 25 of the multiple elements 21 are connected together to a common electrode 27, the emitters are connected to a common earth 28, also connected to the microcircuits, while the brightness is modulated by the control of the electrode 24 by the microcircuit. In this case, there are accordingly three common electrodes.

FIG. 3 represents another embodiment in which the display element 31, with two electrodes, is mounted in series with the microcircuit 32 between the two common electrodes 33 and 34.

FIG. 4 represents another embodiment in which the display element 41 is provided with a transformer, consisting of a primary circuit 44 and a secondary circuit 43, optionally interconnected by a connection 45. The microcircuit 42 is mounted in series with the primary circuit which it controls.

FIG. 5 represents another embodiment with a transformer similar to FIG. 4, the display element 51 being here a discharge tube or a cathode ray tube with field emission, the primary circuit 53 is connected to the microcircuit 52 and to a common electrode 56 devoted to power distribution, the addressing being implemented on another electrode 57 and a common earth 55.

FIG. 6 represents another possible embodiment in which each microcircuit 64 controls a number of display elements, for example three elementary color points 61, 62, 63 of a single pixel. The microcircuit can then contain several addresses or receive after its address a group of information corresponding to the various elements which it controls.

Assemblies in series as shown in FIG. 1, 3, 4 or 6 suppose devices in the addressing system and microcircuits capable of separating, for example temporally, the functions for transmitting address and brightness data at high frequency and low power level and the brightness modulation functions at low frequency and at the highest power level. To the addressing electrodes can also be added direct current providing the power for modulating the addressing signals, the microcircuit implementing the separation of the signals.

Assemblies such as those shown in FIG. 2 or FIG. 5 have separate electrodes to distribute the power and for addressing; they therefore simplify the microcircuit but need at least three common electrodes.

The setting up according to the invention of an integrated microcircuit per display element brings many advantages, some of which some are described below:
Individual addressing eliminates the need to produce networks of rows and columns as in the conventional implementations of matrix screens. According to the invention, the microcircuits are connected in parallel on common electrodes. These common electrodes can be used for addressing and for power supply.
Individual addressing can give any form desired to the display screen, without being restricted to the conventional rectangular structure imposed by traditional addressing by rows and columns.
It becomes possible to divide a screen into smaller units of any shape. Thus, the manufacture of a standard size of screen which will then be divided into smaller screens on demand can be considered.
It also becomes possible to repair an area of the screen which is defective.
Each microcircuit can correct brightness differences from one light element to another, either by local measurement, for example of the emission current and correcting it by comparison with an integrated reference voltage, or by external measurement, during a calibration phase, of the characteristics of each element, calculation of the correction coefficients necessary to improve uniformity and sending these correction coefficients to each microcircuit.
As modulation of the lighting of the display element is managed locally by the microcircuit this element can then be operated with a much greater cyclic ratio than an addressing system with rows and columns. The high cyclic ratio avoids flickering and above all can work with much lower instantaneous brightness and thus, particularly for a screen with field emission and luminophores, with a higher light efficiency. The positioning of the various constituents gives the subject of the invention a maximum of useful effects which were not hitherto obtained by similar devices.

Each microcircuit will be able to record, in addition to its individual address and in a preset order, the addresses of one or more display elements, sometimes adjacent, and be capable, if it detects the transmission of one of said recorded addresses, to count the number of brightness data sent in series and without a new address, and to load after this counting the data which is addressed to it.

Moreover, if the microcircuit has means which enable it to detect that the user has touched or pressed the screen close to the corresponding display element, it will have means of sending this information, with its individual address, on common addressing and power supply electrodes.

1. A display device comprising individual elements wherein the placement, on each element, of an electronic microcircuit capable of recognizing its address among those of other microcircuits connected in parallel to the common addressing electrodes, recording the brightness data sent to its address and modulating the brightness of its display element according to the data received.

2. The device of claim 1, wherein it includes one display element and one microcircuit per elementary color point of the image.

3. The device of claim 1, wherein each microcircuit manages several color points or elementary points adjacent to the image on one or more addresses.

4. The device of claim 1, wherein the individual addresses are engraved on a microcircuit during its manufacture and remain visible for optical reading of this said address during assembly of the display screen.

5. The device of claim 1, wherein the individual addresses are written electrically in a non-volatile memory area of the microcircuit during assembly of the display screen.

6. The device of claim 1, wherein the display screen is divided into several addressing areas controlled independently and simultaneously so as to reduce the frequency of the addressing signals.

7. The device of claim 1, wherein each microcircuit can record, in addition to its individual address and in a preset order, the addresses of one or more display elements, adjacent or otherwise, and is capable, if it detects the transmission of one of said recorded addresses, of counting the number of brightness data sent in series and without a new address, and loading after this counting the data which is addressed to it.

8. The device of claim 1, wherein the microcircuit has means enabling it to detect that the user has touched or pressed the screen close to the corresponding display element and means to send this information back, with its individual address, to the common addressing and power supply electrodes.

9. The device of claim 1, wherein the microcircuit has means enabling it to correct the modulation of its display element according to a local measurement, for example of the current, or a correction coefficient sent by the addressing system.

10. The device of claim 1, wherein the microcircuit has means enabling it to recognize certain preset global addresses and then to place itself in a preset test mode.
